(19) United States
(12) Patent Application Publication
(10) Pub. No.: US 2018/0107268 A1
(43) Pub. Date: Apr. 19, 2018

(54) Sensory Immersion Facilitating System

(71) Applicant: Ross Crandall, Woodbury, MN (US)

(72) Inventor: Ross Crandall, Woodbury, MN (US)

(21) Appl. No.: 15/782,587

(22) Filed: Oct. 12, 2017

Related U.S. Application Data
(60) Provisional application No. 62/408,326, filed on Oct. 14, 2016.

(51) Int. Cl. G06F 3/01; G06T 19/00; G02B 27/01

(52) U.S. Cl. CPC G06F 3/011; G02B 27/017; G06T 19/003

(57) ABSTRACT

A sensory immersion facilitating system includes a housing having a bottom wall and a perimeter wall. The housing includes a door for accessing an interior of the housing. A chair is positioned in the housing and a virtual reality headset is positioned within the housing. A computer is in communication with the virtual reality headset. An environmental control apparatus is in communication with the computer and is actuated to control a humidity level and a temperature of an interior of the housing. The computer is programmed with a simulation so that the computer provides a visual output to the virtual reality headset associated with the simulation. The computer further controls the environmental control apparatus such that a temperature and a humidity within the housing is within parameters assigned by the simulation.

### CROSS-REFERENCE TO RELATED APPLICATIONS

I hereby claim the benefit under 35 U.S.C. Section 119(e) of U.S. Provisional application 62/408,326 filed on Oct. 14, 2016.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98

The disclosure and prior art relates to sensory stimulation devices and more particularly pertains to a new sensory stimulation device for immersing a person in a virtual reality experience including visual, audio, and physical components.

### BRIEF SUMMARY OF THE INVENTION

An embodiment of the disclosure meets the needs presented above by generally comprising a housing has a bottom wall and a perimeter wall. The housing includes a door for accessing an interior of the housing. A chair is positioned in the housing and a virtual reality headset is positioned within the housing. A computer is in communication with the virtual reality headset. An environmental control apparatus is in communication with the computer and is actuated to control a humidity level and a temperature of an interior of the housing. The computer is programmed with a simulation so that the computer provides a visual output to the virtual reality headset associated with the simulation. The computer further controls the environmental control apparatus such that a temperature and a humidity within the housing is within parameters assigned by the simulation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a sensory immersion facilitating system according to an embodiment of the disclosure.

FIG. 2 is a front perspective view of an embodiment of the disclosure.

FIG. 3 is a rear view of an embodiment of the disclosure.

FIG. 4 is a schematic view of an embodiment of the disclosure.

FIG. 5 is a schematic view of an embodiment of the disclosure.

FIG. 6 is a broken front perspective view of an embodiment of the disclosure.

FIG. 7 is a schematic view of an embodiment of the disclosure.

### DETAILED DESCRIPTION OF THE INVENTION

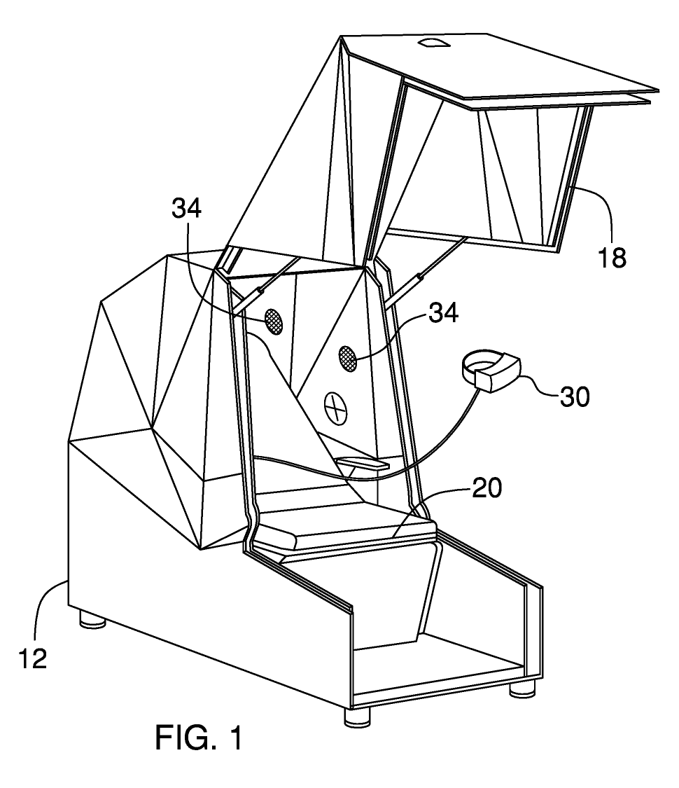

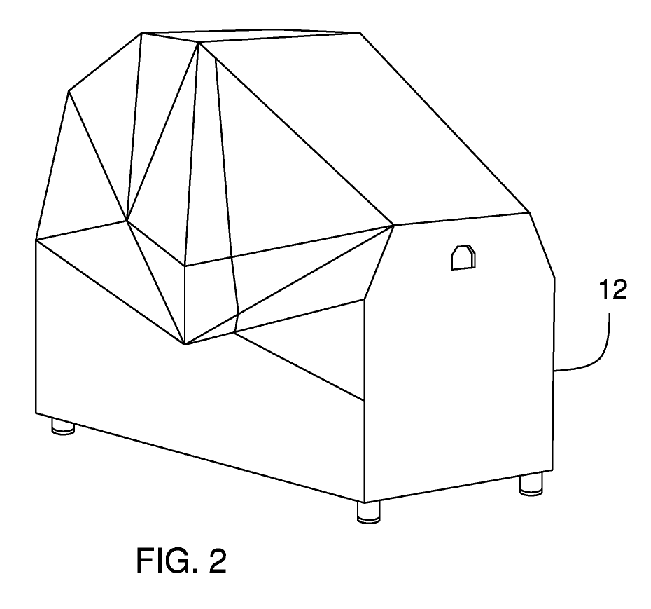

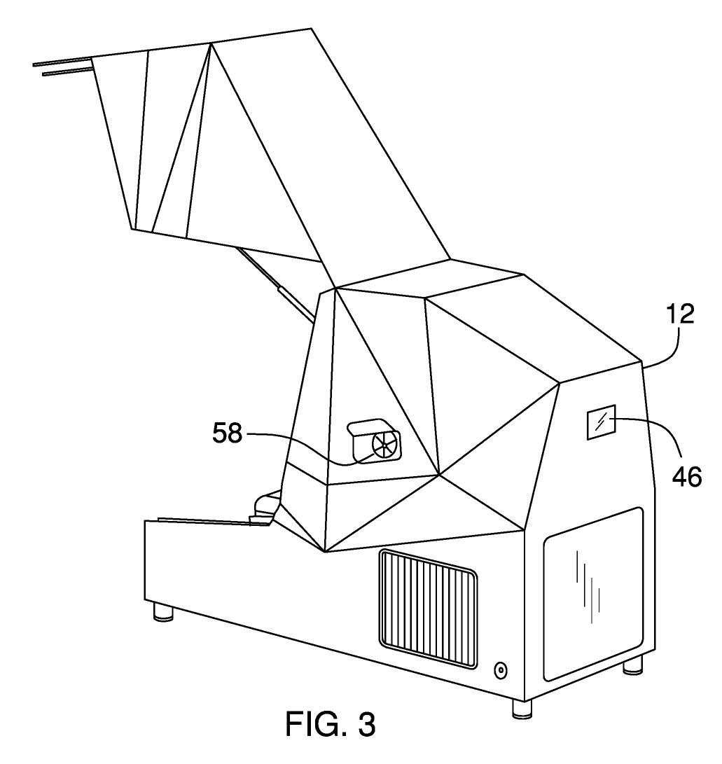

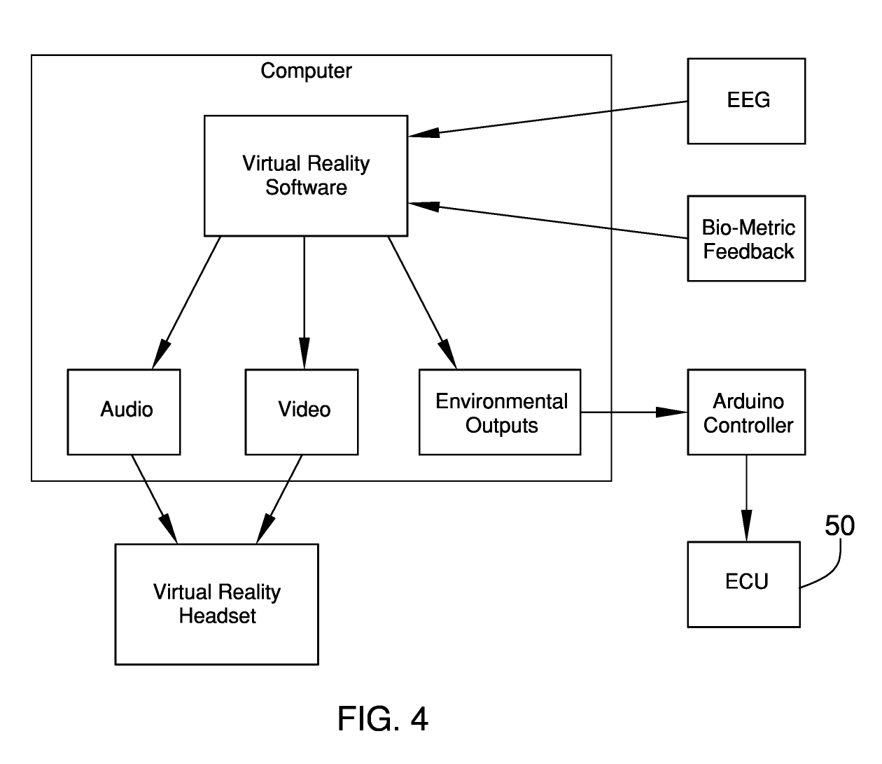

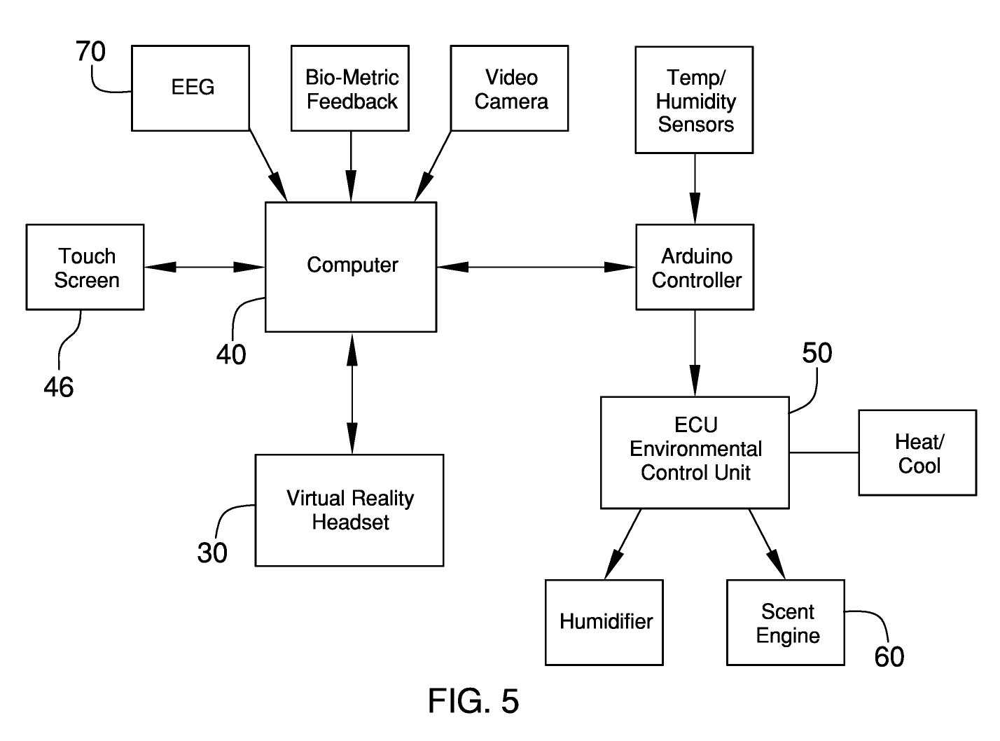

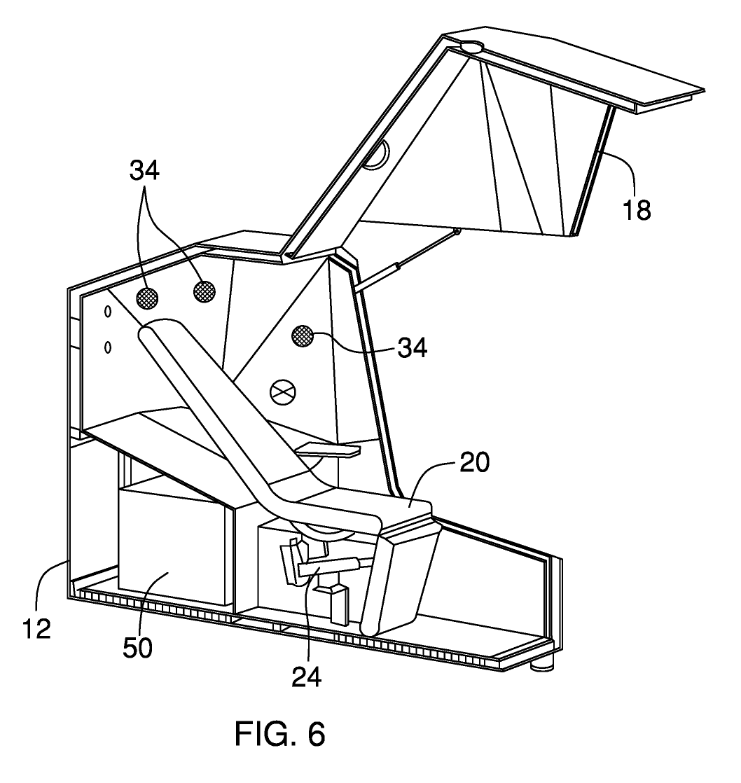

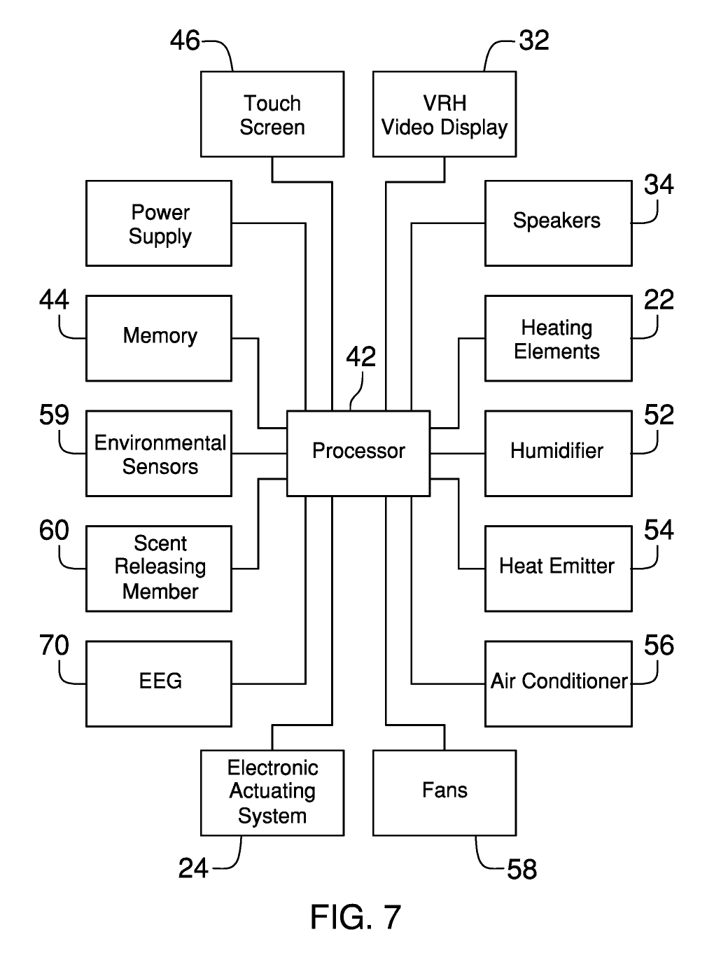

With reference now to the drawings, and in particular to FIGS. 1 through 7 thereof, a new sensory stimulation device embodying the principles and concepts of an embodiment of the disclosure and generally designated by the reference numeral 10 will be described.

As best illustrated in FIGS. 1 through 7, the sensory immersion facilitating system 10 generally comprises a housing 12 which includes a bottom wall and a perimeter wall. The housing 12 may have any configuration desired but will typically be constructed to have room to hold only one or two people, though larger sizes may be optional. Generally then, the housing will have a length being less than 12.0 feet, a width less than 5.0 feet and a height less than 8.0 feet. The housing 12 includes a door 18 for accessing an interior of the housing 12. As can be seen in the Figure, the door 18 may be a door that lifts upwardly for access into the interior though alternately styled access doors may be provided.

A chair 20 may be positioned in the housing for providing a place for a person to sit, recline, or lie down within the housing 12. The chair 20 would preferably be adjustable in a conventional manner to allow the user's posture to be altered as desired and may comprise an electronic actuating system 24 for electrically moving the back, seat and leg rest thereof. Controls for the chair 20 may be provided such that they are controllable by the person seated in the chair 20 and which may also be controlled by other persons or by a computer program such that the chair 20 is selectively adjusted during the usage of the system 10 to enhance the simulation experience. Further, the chair 20 may include heating elements 22 and/or cooling elements to alter the temperature of the chair 20.

A virtual reality headset (VRH) 30, or assembly, is positioned within the housing 12 while the assembly 10 is being used. The VRH 30 is conventional in design and will be worn by a user of the system 10 to provide a visual sensation of a selected environment. VRH 30 may include an audio component as well as a visual component, wherein the video component comprises video display 32 within the VHR 30, though the audio component may be separate and comprise one or more speakers 34 mounted in the housing and possibly placed on the chair.

A computer 40, and its processor 42, is in communication with the VRH 30 and may be wired thereto or may be in wireless communication with the VRH 30 using Bluetooth or other conventional wireless technologies. The computer 40 is programed to run at least one simulation and is preferably programmed to run a number of simulations. The simulations may be tailored to a specific individual's needs or requirements, or the simulations may include a plurality of stock simulations from which a user selects. The computer includes conventional memory 44 and may include a connection to the internet to allow updates, controlling of the computer 40 and modifications as needed. The computer may include a touch screen 46 that displays the simulation being played and act as an input for controlling the computer 40 to select a desired simulation.

The simulations may cover a nearly infinite number of scenarios such as deep meditation, relaxation, visualization training, anxiety disorder therapies, to name just a few. However, the simulations will typically include several primary elements. The first element is a visual one which is supplied by the VRH 30. The VRH 30 is simply programmed to provide a visual scene of what is desired. Thus, for instance, if a person wishes to relax and finds that being on a beach is relaxing, the VRH 30 would display a beach to provide the visual impression of being on the beach. The audio component, or speakers 30, would therefore provide sounds associated with a beach such as waves crashing onto a beach, wind moving through trees, birds being heard in the distance.

A second element would include an environmental control apparatus 50 being in communication with the computer. The environmental control apparatus is actuated to control a humidity level and a temperature of an interior of the housing 12. Particularly, the environmental control apparatus is utilized to provide the user of the system 10 with a physical sense of the environment displayed by the VRH 30. Therefore, if the VRH 30 is showing a beach with bright sun, the VRH would utilize a humidifier 52 to increase humidity and a heat emitter 54 to warm the interior of the housing 12. The heat emitter 54 may comprise an electric heater, heat lamps, radiant heat emitters and the like. Should the VRH 30 be displaying a cooler scene, cold air from an air conditioner 56 may be injected into the housing 12 to cool the interior of the housing 12 and if needed dehumidified air may be supplied to the housing 12. The environmental control apparatus 50 may be integral to the housing 12 or may comprise a separate unit utilizing air conduits that are fluidly coupled to the housing 12 to provide air conditioned as needed for the selected sensory experience.

The environmental control apparatus 50 may further include one or more fans 58 mounted in the housing 12. The fans 58 may be used to not only simulate wind but, depending on their locations, may be used to simulate wind blowing from particular directions. Thus, should the VRH 30 display a kite or sailboat moving in a particular direction relative to the viewpoint of the user of the system 10, the computer 40 would instruct the environmental control apparatus 50 to turn on fans 58 positioned from where it would appear the wind should be blowing. Alternatively, the fans 58 may be directionally motorized to alter their direction as needed.

In addition to conventional structures used for controlling the temperature and humidity of the interior of the housing 12, the environmental control apparatus 50 may further include sensors 59 positioned within the housing 12 for monitoring the temperature and the humidity of the housing 12. These may be strategically placed within the housing 12 to obtain an overall average data point of humidity and temperature so that the computer 40 can alter instructions to the environmental control apparatus 50 as needed to maintain desired thermal and humidity conditions.

A third element contemplated would include a scent releasing member 60 mounted in the housing 12 or included with the environmental control apparatus 50. The scent releasing member 60 would include a plurality of pre-packaged scents that would be placed in fluid communication with the interior of the housing 12 to dispense a specific odor into the housing. The scents would typically be aligned with the selected scenario. If the scenario was deep meditation, the scent may include an incense type smell or a smell from an essential oil known to have calming attributes such as lavender, vanilla or cinnamon. However, other scents may be provided directed to a particular visual stimulus. For example, a rose scent may be provided should the user of the system see roses, or ocean air if they are on a beach. The scent may be deployed in any conventional manner used for dispensing a scent.

A fourth element which may or may not be included would be an electroencephalograph 70 (EEG) for monitoring Theta, Beta, Alpha and Gamma frequencies as well as biometric readers for determining pulse rate, blood pressure and the like. These too would be in communication with the computer 40. Such information would be used to specifically control the brainwave patterns of the user to build a user profile such that the user could more quickly obtain a predetermined mental state by recognizing which sensory triggers correlate to the desired effects. These correlations may be used to form a general pattern so that they may be used with a new user of the system 10 as well.

In use, a user selects the type of scenario/simulation/experience desired using the computer. The computer 40 may include a touchscreen or other conventional interface for selecting the program to be started. The user then enters the housing 12, closes the door 18 and places the VRH 30 over their eyes. The computer 40 begins the simulation by providing visual and audio stimulus while monitoring the internal environment of the housing 12. The temperature, humidity, air movement, and scent may all be adjusted by the computer depending on the visual stimulus being provided. Additionally, if provided, the user's brainwaves are monitored to further adjust the environmental, audio and visual outputs as needed to achieve a desired effect and full physical immersion into the simulation.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sensory stimulating assembly configured for immersing a person in a virtual reality environment comprises:
a housing having a bottom wall and a perimeter wall, said housing including a door for accessing an interior of said housing;
a chair being positioned in said housing;
a virtual reality headset being positioned within said housing, said virtual reality headset including a visual component;
a computer being in communication with said virtual reality headset;
an environmental control apparatus being in communication with said computer, said environmental control apparatus being actuated to control a humidity level and a temperature of an interior of said housing; and
said computer being programmed with a simulation, said computer providing a visual output to said virtual reality headset associated with said simulation, said computer controlling said environmental control apparatus such that a temperature and a humidity within said housing is within parameters assigned by said simulation.

2. The sensory stimulating assembly according to claim 1, wherein said chair is an adjustable chair and being configured to allow a posture of a person sitting in said chair to be altered.

3. The sensory stimulating assembly according to claim 1, wherein said chair includes heating elements to alter a temperature of said chair.

4. The sensory stimulating assembly according to claim 1, further including an audio component being positioned within said housing and being electrically coupled to said computer, said simulation including an audio element played by said audio component, said visual and audio elements being associated with each other.

5. The sensory stimulating assembly according to claim 1, wherein said simulation is selected from the group including deep meditation, relaxation, visualization training and anxiety disorder therapies.

6. The sensory stimulating assembly according to claim 1, wherein said environmental control apparatus includes a heat emitter and an air cooling assembly.

7. The sensory stimulating assembly according to claim 1, further including a fan being mounted within said housing and being electrically coupled to said computer, said fan being actuated in association with said simulation to blow air toward said chair to simulate wind.

8. The sensory stimulating assembly according to claim 1, further including an environmental sensor being mounted within said housing and being electrically coupled to said computer, said environmental sensor detecting a temperature and a humidity within said housing, said environmental control apparatus altering a temperature or humidity of said interior of said housing in association with said simulation and temperature and humidity levels detected by said environmental sensor.

9. The sensory stimulating assembly according to claim 1, further including a scent releasing member being in fluid communication with an interior of said housing and being electrically coupled to said computer, said scent releasing member releasing an odor into said housing in association with said simulation.

10. The sensory stimulating assembly according to claim 1, further including an electroencephalograph being positioned within said housing and being electrically coupled to said computer, said electroencephalograph being configured to monitor Theta, Beta, Alpha and Gamma frequencies an receive biometric readers for determining pulse rate and blood pressure of a person positioned within said housing.

11. The sensory stimulating assembly according to claim 2, further including an audio component being positioned within said housing and being electrically coupled to said computer, said simulation including an audio element played by said audio component, said visual and audio elements being associated with each other.

12. The sensory stimulating assembly according to claim 11, wherein said chair includes heating elements to alter a temperature of said chair.

13. The sensory stimulating assembly according to claim 12, wherein said environmental control apparatus includes a heat emitter and an air cooling assembly.

14. The sensory stimulating assembly according to claim 13, further including a fan being mounted within said housing and being electrically coupled to said computer, said fan being actuated in association with said simulation to blow air toward said chair to simulate wind.

15. The sensory stimulating assembly according to claim 14, further including an environmental sensor being mounted within said housing and being electrically coupled to said computer, said environmental sensor detecting a temperature and a humidity within said housing, said environmental control apparatus altering a temperature or humidity of said interior of said housing in association with said simulation and temperature and humidity levels detected by said environmental sensor.

16. The sensory stimulating assembly according to claim 14, further including a scent releasing member being in fluid communication with an interior of said housing and being electrically coupled to said computer, said scent releasing member releasing an odor into said housing in association with said simulation.

17. The sensory stimulating assembly according to claim 16, further including an electroencephalograph being positioned within said housing and being electrically coupled to said computer, said electroencephalograph being configured to monitor Theta, Beta, Alpha and Gamma frequencies an receive biometric readers for determining pulse rate and blood pressure of a person positioned within said housing.

18. A sensory stimulating assembly configured for immersing a person in a virtual reality environment comprises:
a housing including a bottom wall and a perimeter wall, the housing having a size configured to hold one person or two people, a door being mounted on said perimeter wall, said door being positionable in an open condition to allow access to an interior of said housing;
a chair being positioned in said housing, said chair being an adjustable chair and being configured to allow a posture of a person sitting in said chair to be altered, said chair including heating elements to alter a temperature of said chair;
a virtual reality headset being positioned within said housing, said virtual reality headset including a visual component;
an audio component being positioned within said housing;
a computer being in communication with said virtual reality headset, said computer being programmed to run at least one simulation, said simulation being selected from the group including deep meditation, relaxation, visualization training and anxiety disorder therapies, said simulation a visual element displayed by said virtual reality headset, said simulation including an audio element played by said audio component, said visual and audio elements being associated with each other;
an environmental control apparatus being in communication with the computer and controlling an environment of said interior of said housing, said environmental control apparatus creating an environment within said housing associated with said simulation, said environmental control apparatus controlling a humidity and a temperature of said interior of said housing, said environmental control apparatus including a heat emitter and an air cooling assembly;
a fan being mounted within said housing and being electrically coupled to said computer, said fan being actuated in association with said simulation to blow air toward said chair to simulate wind;
an environmental sensor being mounted within said housing and being electrically coupled to said computer, said environmental sensor detecting a temperature and a humidity within said housing, said environmental control apparatus altering a temperature or humidity of said interior of said housing in association with said simulation and temperature and humidity levels detected by said environmental sensor;
a scent releasing member being in fluid communication with an interior of said housing and being electrically coupled to said computer, said scent releasing member releasing an odor into said housing in association with said simulation; and
an electroencephalograph being positioned within said housing and being electrically coupled to said computer, said electroencephalograph being configured to monitor Theta, Beta, Alpha and Gamma frequencies an receive biometric readers for determining pulse rate and blood pressure of a person positioned within said housing.
